(19) United States
(12) Patent Application Publication
(10) Pub. No.: US 2005/0202118 A1
(43) Pub. Date: Sep. 15, 2005

(54) Chewing gum products containing trigeminal stimulant and method of making the same

(76) Inventors: Sonya S. Johnson, LaGrange Highlands, IL (US); Michael J. Greenberg, Northbrook, IL (US); Robert J. Yatka, Orland Park, IL (US)

Correspondence Address: Bell, Boyd & Lloyd LLC, P.O. Box 1135, Chicago, IL, 60690-1135, US

(21) Appl. No.: 11/072,552

(22) Filed: Mar. 3, 2005

Related U.S. Application Data
(63) Continuation-in-part of application No. 10/866,211, filed on Jun. 10, 2004, now abandoned.
Application No. 10/866,211 is a continuation-in-part of application No. 10/127,858, filed on Apr. 22, 2002.
Application No. 10/127,858 is a continuation-in-part of application No. PCT/US96/17227, filed on Oct. 28, 1996.

(51) Int. Cl. A23G 3/30

(52) U.S. Cl. 426/3

(57) ABSTRACT

Chewing gums and methods of making same that have improved flavor duration by stimulating a trigeminal nerve of a consumer of the chewing gum are provided. The chewing gums of the present invention includes a trigeminal stimulant. The trigeminal stimulant stimulates the trigeminal nerve of the consumer to provide longer lasting flavor duration.

### CROSS-REFERENCE TO RELATED APPLICATIONS

This application is a continuation-in-part of U.S. patent application Ser. No. 10/866,211, which is a continuation-in-part of PCT Application No. PCT/US96/17227, filed on Oct. 28, 1996 entitled “Chewing Gum Products Containing Perillartine and Method of Making the Same” and a continuation-in-part of U.S. patent application Ser. No. 10/127,858, filed on Apr. 22, 2002 entitled “A Chewing Gum Having Prolonged Sensory Benefits” the entire disclosures of which are hereby incorporated by reference.

### BACKGROUND OF THE INVENTION

Chewing gum compositions typically include gum base, flavoring and bulking and sweetening agents, as well as other optional ingredients such as softeners and coloring. Bulking and sweetening agents often include sugar, glucose syrup and high-intensity sweeteners. High-intensity sweeteners are most commonly used in conjunction with sugarless sweeteners. Sweetening agents generally are rapidly released from the chewing gum product. As a result of early release, chewing gum products tend to lose their sweetness after a short period of time. A need, therefore, exists for a method of improving and maintaining the sweetness characteristics of chewing gum products.

Chewing gum compositions typically include ingredients such as gum base, flavoring agents, bulking agents, sweeteners and other optional ingredients including softeners and coloring agents. Bulking agents and sweeteners often include sugar, glucose syrup and high-intensity sweeteners. The high-intensity sweeteners are most commonly used as applied to sugarless sweeteners.

The gum base defines a water insoluble portion that remains in the mouth of the consumer as the chewing gum is chewed. Flavor and sweeteners define a water soluble portion that is released during the chew. The release of flavors is one of, if not the most desirable, characteristics of chewing gum.

It is desirable to prolong and enhance the sensory benefits, such as flavor, sweeteners, and cooling sensations of the chewing gum as it is chewed. Thus, a variety of methods and compositions for prolonging the release of flavor and sweeteners have been considered and utilized.

With respect to flavors, it is known that the flavor sensation of the chewing gum during chewing can be enhanced and prolonged if the release of sweeteners can be controlled and prolonged. But, sweeteners typically are rapidly released from the chewing gum product. As a result of such an early and rapid release of sweeteners, the chewing gum products lose their flavor after a short period of time.

To address this issue, encapsulating agents are known and used to control and prolong the release of sweeteners. In general, the encapsulating agents include a variety of different food grade encapsulating materials, such as food grade shellac, that can be applied to the gum in a variety of different ways, such as wet granulation, wax granulation, spray drying, spray chilling, fluid bed coating, coacervation, fiber extension and the like. However, the use of encapsulating agents can be expensive and may not be as effective to prolong the release of sweeteners as desired.

A need, therefore exists, for improved chewing gums that exhibit prolonged sensory benefits as the gum is chewed.

### SUMMARY OF THE INVENTION

According to the present invention, it has now been discovered that it is possible to use a level of an oral trigeminal stimulant that is not detectable, such as a low level cooling agent, in chewing gum and stimulate the trigeminal nerve of a consumer of the chewing gum product, providing the chewing gum with improved flavor duration, and provides improved sensory benefits. Use of a low level of trigeminal stimulant in chewing gum has a significant advantage over other methods for prolonging flavor in chewing gums. For example, the use of cooling agents in chewing gum not only improves flavor duration, but also, unexpectedly, provides unique trigeminal oral sensations.

Thus, the present invention relates to a method of improving and maintaining flavor and improving sensory benefits of chewing gum products by adding a trigeminal stimulant to the chewing gum composition at a level that is not perceptible, by taste, by the consumer. The invention also includes chewing gum products containing a low level of trigeminal stimulant.

In one embodiment, the invention is a chewing gum product having prolonged flavor duration and improved sensory benefits comprising from about 5% to about 95% by weight gum base, from about 5% to about 95% by weight bulking and sweetening agents, from about 0.1% to about 15% by weight of a flavor and from about 0.005% to about 0.5% by weight of a trigeminal stimulant.

As noted above, the trigeminal stimulant can be a cooling agent. In an especially preferred example of the present invention, the cooling agent is selected from the group consisting of menthol, WS3, N-substituted p-menthane carboxamide, acyclic carboxamides including WS23, methyl succinate and menthone glycerol ketals, other like cooling agents or mixtures thereof. Preferably, the cooling agent will be used in a concentration lower than an amount that can be detected by taste. In addition, bulk sweeteners with a negative heat of reaction such as xylitol, erythritol, dextrose, and sorbitol also cause a cooling effect. The cooling agents of the present invention are useful in chewing gums of all different flavors and types including fruit, mint, peppermint, sugarless, and regular bubblegum flavor. In yet another preferred example of the present invention, the chewing gum composition further includes a hydrophobic sweetener. The hydrophobic sweetener further enhances the effect of the cooling agent to provide longer lasting flavor and improved sensory benefits.

In addition to cooling agents or as a substitute for, additional trigeminal stimulants may be included in the chewing gum composition. To this end, suitable trigeminal stimulants include a tingling agent, Jambu extract, Vanillyl alkyl ethers, Vanillyl n-butyl ether, spilanthol, Echinacea extract, Northern Prickly Ash extract, capsaicin, capsicum oleoresin, red pepper oleoresin, black pepper oleoresin, piperine, ginger oleoresin, gingerol, shoagol, cinnamon oleoresin, cassia oleoresin, cinnamic aldehyde, eugenol, cyclic acetal of vanillin, menthol glycerin ether, unsaturated amides and combinations thereof.

In another embodiment, the invention provides a method of making a chewing gum having prolonged flavor duration and improved sensory benefits comprising the steps of forming a chewing gum composition comprising from about 5% to about 95% by weight gum base, from about 5% to 95% by weight bulking and sweetening agents from about 0.1% to about 15% by of a weight flavor; and adding from about 0.005% to about 0.5% by weight of a trigeminal stimulant.

In an especially preferred example of the method of the present invention, the trigeminal stimulant is a cooling agent selected from the group consisting of menthol, WS3, N-substituted p-menthane carboxamide, acyclic carboxamides including WS23, methyl succinate and menthone glycerol ketals, other like cooling agents or mixtures thereof. Preferably, the cooling agent used in the method of the present invention will be used in a concentration lower than an amount than can be detected by taste but still sufficient to achieve a cooling effect in a chewing gum.

According to the present invention, a trigeminal stimulant is added to chewing gum products preferably below perceived thresholds to improve flavor duration in chewing gum. The unexpected result is that trigeminal stimulants, when used in low concentrations, also provide improved and long lasting sensory benefits. These sensory benefits result from stimulation of the trigeminal nerve and include, but are not limited to, tingling, numbing mouth coating and cooling/warming sensations. The trigeminal effects also enhance the flavor of the chewing gum. These attributes could be very useful in giving the impression of long lasting flavor in products designed to give breath freshness or products designed to provide dental benefits.

Additional features and advantages of the present invention are described in, and will be apparent from, the following Detailed Description of the Invention and the figures.

### DETAILED DESCRIPTION OF THE INVENTION PRESENTLY PREFERRED EMBODIMENTS

As used herein, the term “chewing gum” also includes bubble gum and the like. All percentages are weight percentages unless otherwise specified.

According to the present invention, it has now been discovered that when a trigeminal stimulant is added to chewing gum preferably below perceived thresholds, the gum has an improved and longer lasting flavor. As used herein, “trigeminal stimulant” means an orally consumed product or agent that stimulates the trigeminal nerve. Below perceived thresholds means that a typical consumer would not be able to identify by taste alone that the trigeminal stimulant is present. Trigeminal effects result when certain chemical irritants stimulate the trigeminal nerve ends causing sensations in the mucosa of the eyes, nose and mouth. Trigeminal effects are not a taste, such as sweet or sour, nor an odor. Rather, trigeminal effects are physical oral sensations such as, for example, coolness from menthol or heat from cinnamon or pepper flavors.

The inventors have uniquely discovered that cooling agents can be effectively utilized at low levels to prolong and enhance sensory benefits of the chewing gum, such as flavoring, cooling sensations, tingling sensations or the like, as the gum is chewed. In addition, the present invention can be used to achieve a delayed release of trigeminal stimulation. The chewing gums of the present invention can be composed of ingredients that are readily available and prepared at lower costs as compared to chewing gums that utilize encapsulating agents and methods thereof.

In an embodiment, the chewing gum of the present invention includes a water insoluble base portion, a water soluble portion, a sensorally active component, such as a flavor, a trigeminal stimulant and optionally a hydrophobic sweetener. The addition of the hydrophobic sweetener can facilitate the enhancement and prolonged effect of sensory benefits of the chewing gum as it is chewed. Such sensory benefits can include, for example, flavor sensation, cooling sensations, warming sensations, tingling, numbing, pain, itch, mouth coating, combinations thereof or other oral trigeminal effects.

It is believed that when the trigeminal stimulant is a cooling agent it can be added at a much lower level than the level used in conventional chewing gums so as to not be detected. In this regard, it is believed that the cooling agent does not have to have a significant impact on the taste threshold of the chewing gum and does not have to impart a noticeable sensation. When hydrophobic sweeteners are optionally mixed with the chewing gum composition, the release of other flavor component(s) along with the hydrophobic sweeteners can be prolonged and enhanced as the gum is chewed.

The amount of trigeminal stimulant can suitably vary depending on any number of factors including the stimulant. The preferred level is that which is above the perceived threshold.

In an embodiment, chewing gum includes the hydrophobic sweetener compound in an amount ranging from about 50 to about 5000 Sucrose Equivalents. The Sucrose Equivalent factor is determined by multiplying the weight percent of the hydrophobic compound in the chewing gum by its relative sweetness.

The hydrophobic sweetener of the present invention can include a range of suitably sweet organic compounds and mixtures thereof that have a very low water solubility. Preferably, the hydrophobic sweetener compounds are those set forth in U.S. patent application Ser. No. 10/127,858, filed on Apr. 22, 2002, and incorporated by reference herein. As previously discussed, the hydrophobic sweeteners can be utilized to further enhance and extend the flavor, sweetness, cooling, tingling and other sensory benefits of chewing gums as chewed.

The chewing gum compositions according to the present invention can include cooling agents. The sensation of the cooling agents allows taste perception to be prolonged and enhanced as the gum is chewed. The cooling agents can be added to the chewing gum alone or in combination with flavors or other sensorally active components. The cooling agents can include a range of different suitable materials. For example, the cooling agent can include menthol, WS3, N-substituted p-menthane carboxamide, acyclic carboxamides including WS23, methyl succinate and menthone glycerol ketals, other like cooling agents or mixtures thereof. In addition, bulk sweeteners with a negative heat of reaction such as xylitol, erythritol, dextrose, and sorbitol also cause a cooling effect.

It should be appreciated that the chewing gum of the present invention is not limited to the type, number and amount of cooling agents. The chewing gum of the present invention can include any suitable amount and variety of different sensorally active components or trigeminal stimulants. The trigeminal effects of such components, including, flavor, cooling, tingling, paresthesis, heat, pain, itch, like trigeminal effects or combinations thereof, can be prolonged and enhanced as the gum is chewed as previously discussed.

In an embodiment, the trigeminal stimulants can include, for example, flavors, tingling agents, Jambu extract, Vanillyl alkyl ethers, such as Vanillyl n-butyl ether, spilanthol, Echinacea extract, Northern Prickly Ash extract, capsaicin, capsicum oleoresin, red pepper oleoresin, black pepper oleoresin, piperine, ginger oleoresin, gingerol, shoagol, cinnamon oleoresin, cassia oleoresin, cinnamon oleoresin, cassia oleoresin, cinnamic aldehyde, eugenol, cyclic acetal of vanillin and menthol glycerin ether, unsaturated amides, like components or combinations thereof.

With respect to other ingredients, the chewing gum of the present invention generally consists of a water insoluble gum base, a water soluble portion, and flavors. The water soluble portion dissipates with a portion of the flavor over a period of time during chewing. The gum base portion is retained in the mouth throughout the chew.

The insoluble gum base generally comprises elastomers, resins, fats and oils, softeners, and inorganic fillers. The gum base may or may not include wax. The insoluble gum base can constitute approximately 5 to about 95 percent, by weight, of the chewing gum, more commonly, the gum base comprises 10 to about 50 percent of the gum, and in some preferred embodiments, 20 to about 35 percent, by weight, of the chewing gum.

In an embodiment, the chewing gum base of the present invention contains about 20 to about 60 weight percent synthetic elastomer, 0 to about 30 weight percent natural elastomer, about 5 to about 55 weight percent elastomer plasticizer, about 4 to about 35 weight percent filler, about 5 to about 35 weight percent softener, and optional minor amounts (about one percent or less) of miscellaneous ingredients such as colorants, antioxidants or the like.

Synthetic elastomers may include, but are not limited to, polyisobutylene with GPC weight average molecular weight of about 10,000 to about 95,000 isobutylene-isoprene copolymer (butyl elastomer), styrene-butadiene copolymers having styrene-butadiene ratios of about 1:3 to about 3:1, polyvinyl acetate having GPC weight average molecular weight of about 2,000 to about 90,000, polyisoprene, polyethylene, vinyl acetate-vinyl laurate copolymer having vinyl laurate content of about 5 to about 50 percent by weight of the copolymer, and combinations thereof.

Preferred ranges are, for polyisobutylene, 50,000 to 80,000 GPC weight average molecular weight, for styrene-butadiene, 1:1 to 1:3 bound styrene-butadiene, for polyvinyl acetate, 10,000 to 65,000 GPC weight average molecular weight with the higher molecular weight polyvinyl acetates typically used in bubble gum base, and for vinyl acetate-vinyl laurate, vinyl laurate content of 10-45 percent.

Elastomer plasticizers may include, but are not limited to, natural rosin esters such as glycerol esters of partially hydrogenated rosin, glycerol esters polymerized rosin, glycerol esters of partially dimerized rosin, glycerol esters of rosin, pentaerythritol esters of partially hydrogenated rosin, methyl and partially hydrogenated methyl esters of rosin, pentaerythritol esters of rosin; synthetics such as terpene resins derived from alpha-pinene, beta-pinene, and/or d-limonene; and any suitable combinations of the foregoing. The preferred elastomer plasticizers will also vary depending on the specific application, and on the type of elastomer which is used.

Fillers/texturizes may include magnesium and calcium carbonate, ground limestone, silicate types such as magnesium and aluminum silicate, clay, alumina, talc, titanium oxide, mono-, di- and tri-calcium phosphate, cellulose polymers, such as wood, and combinations thereof.

Softeners/emulsifiers may include tallow, hydrogenated tallow, hydrogenated and partially hydrogenated vegetable oils, cocoa butter, glycerol monostearate, glycerol triacetate, lecithin, mono-, di- and triglycerides, acetylated monoglycerides, fatty acids (e.g., stearic, palmitic, oleic and linoleic acids), and combinations thereof.

Colorants and whiteners may include FD&C-type dyes and lakes, fruit and vegetable extracts, titanium dioxide, and combinations thereof.

The base may or may not include wax. An example of a wax-free gum base is disclosed in U.S. Pat. No. 5,286,500, the disclosure of which is incorporated herein by reference.

In addition to a water insoluble gum base portion, a typical chewing gum composition includes a water soluble bulk portion and one or more flavoring agents. The water soluble portion can include bulk sweeteners, high intensity sweeteners, flavoring agents, softeners, emulsifiers, colors, acidulants, fillers, antioxidants, and other components that provide desired attributes.

Softeners are added to the chewing gum in order to optimize the chewability and mouth feel of the gum. The softeners, which are also known as plasticizers and plasticizing agents, generally constitute between approximately 0.5 to about 15% by weight of the chewing gum. The softeners may include glycerin, lecithin, and combinations thereof. Aqueous sweetener solutions such as those containing sorbitol, hydrogenated starch hydrolysates, corn syrup and combinations thereof, may also be used as softeners and binding agents in chewing gum.

Bulk sweeteners include both sugar and sugarless components. Bulk sweeteners typically constitute 5 to about 95% by weight of the chewing gum, more typically, 20 to 80% by weight, and more commonly, 30 to 60% by weight of the gum.

Sugar sweeteners generally include saccharide-containing components commonly known in the chewing gum art, including, but not limited to, sucrose, dextiose, maltose, dextrin, dried invert sugar, fructose, levulose, galactose, corn syrup solids, and the like, alone or in combination.

Sugarless bulk sweeteners include, but are not limited to, sugar alcohols such as sorbitol, mannitol, xylitol, hydrogenated starch hydrolysates, maltitol, and the like, alone or in combination.

High intensity artificial sweeteners, other than the hydrophobic sweeteners of the present invention, can also be used, alone or in combination with the above. Preferred sweeteners include, but are not limited to sucralose, aspartame, salts of acesulfame, alitame, saccharin and its salts, cyclarnic acid and its salts, glycyrrhizin, dihydrochalcones, thaumatin, monellin, and the like, alone or in combination.

Usage level of the artificial sweetener will vary greatly and will depend on such factors as potency of the sweetener, rate of release, desired sweetness of the product, level and type of flavor used and cost considerations. Thus, the active level of artificial sweetener may vary from 0.02 to about 8%.

Combinations of sugar and/or sugarless sweeteners may be used in chewing gum. Additionally, the softener may also provide additional sweetness such as with aqueous sugar or alditol solutions.

If a low calorie gum is desired, a low caloric bulking agent can be used. Examples of low caloric bulking agents include: polydextrose; Raftilose, Raftilin; Fructooligosaccharides (NutraFlora); Palatinose oligosaccharide; Guar Gum Hydrolysate (Sun Fiber); or indigestible dextrin (Fibersol). However, other low calorie bulking agents can be used.

A variety of flavoring agents can be used. The flavor can be used in amounts of approximately 0.1 to about 15 weight percent of the gum, and preferably, 0.2 to 5%. Flavoring agents may include essential oils, synthetic flavors or mixtures thereof including, but not limited to, oils derived from plants and fruits such as citrus oils, fruit essences, peppermint oil, spearmint oil, other mint oils, clove oil, oil of wintergreen, anise and the like. Artificial flavoring agents and components may also be used. Natural and artificial flavoring agents may be combined in any sensorally acceptable fashion.

Additional oral health ingredients may be added including but not limited to, antiplaque/anti-gingivitis agents (such as chlorhexidine, CPC, triclosan), pH control agents (including Urea and buffers,) other inorganic components for tarter or caries control (phosphates, fluoride) and biological agents (antibodies, enzymes). The only requirement is that the agents be safe and effective and that they do not react undesirably with each other such as may happen with phosphate salts.

As previously discussed, the present invention provides a method for producing the chewing gum of the present invention. It should be appreciated that the method of making or producing the chewing gum of the present invention can be carried out by any number and variation of suitable processes, such as blending, mixing and/or cooking the ingredients to obtain a desirable consistency or the like. It should also be appreciated that the chewing gum of the present invention can be formed into any suitable size and shape, such as sticks, chunks, pellets or the like.

In an embodiment, a number of chewing gum ingredients at least including a water insoluble base portion, a water soluble portion, a flavor, a trigeminal stimulant, such as a cooling agent, and optionally additional sensorally active components or mixture thereof are processed to form the chewing gum of the present invention. It should be appreciated that the ingredients can be added in any suitable amount.

As previously discussed, the chewing gum ingredients can be processed in any suitable way to form the chewing gum of the present invention. In an embodiment, a cooling agent is pre-mixed with the flavor, hydrophobic sweetener, or additional sensorally active components of the chewing gum or combinations thereof. The inventors have uniquely discovered that pre-mixing of the ingredients, particularly the cooling agent and the hydrophobic sweetener, can aid in synchronizing the release of same and further can facilitate uniform incorporation of these ingredients into the chewing gum mass.

By way of example and not limitation, the following examples illustrate the formulations of chewing gums embodying the present invention.

### EXAMPLE NO. 1

| | |
|---|---|
| Gum Base | 19.83 |
| Sugar | 63.57 |
| Glucose Syrup | 10.43 |
| Sweeteners | 0.62 |
| Lecithin | 0.80 |
| Glycerine | 3.58 |
| Flavor | 1.16 |
| Color | 0.03 |
| | 100.00 |

### EXAMPLE NO. 2

| | |
|---|---|
| Gum Base | 19.83 |
| Sugar | 63.55 |
| Glucose Syrup | 10.43 |
| Sweeteners | 0.62 |
| Lecithin | 0.80 |
| Glycerine | 3.58 |
| Flavor | 1.16 |
| Color | 0.03 |
| WS 23 | 0.02 |
| | 100.00 |

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A chewing gum product having improved flavor duration by stimulating a trigeminal nerve of a consumer of the chewing gum product comprising:
a) about 5% to about 95% by weight gum base;
b) about 5% to about 95% by weight bulking and sweetening agents;
c) about 0.1% to about 15% by weight of a flavor; and
d) a trigeminal stimulant present at a level that is not perceptible but is sufficient to stimulate the trigeminal nerve of a consumer.

2. The chewing gum product of claim 1 wherein the trigeminal stimulant is a cooling agent selected from the group consisting of: menthol, WS3, N-substituted p-menthane carboxamide, acyclic carboxamides including WS23, methyl succinate and menthone glycerol ketals, or mixtures thereof.

3. The chewing gum product of claim 1 wherein the chewing gum includes less than a typical amount of cooling agent that is used to achieve a cooling effect.

4. The chewing gum product of claim 1 wherein the flavor is a mint flavor.

5. The chewing gum product of claim 1 wherein the flavor is a fruit flavor.

6. The chewing gum product of claim 1 wherein the chewing gum product is a sugarless chewing gum.

7. The chewing gum product of claim 1 wherein the flavor is regular bubblegum.

8. The chewing gum product of claim 1 further comprising a hydrophobic sweetener.

9. The chewing gum product of claim 1 wherein the trigeminal stimulant is a bulk sweetener with a negative heat of reaction.

10. The chewing gum product of claim 1 wherein the trigeminal stimulant is selected from the group consisting of: a flavor, a tingling agent, Jambu extract, Vanillyl alkyl ethers, Vanillyl n-butyl ether, spilanthol, Echinacea extract, Northern Prickly Ash extract, capsaicin, capsicum oleoresin, red pepper oleoresin, black pepper oleoresin, piperine, ginger oleoresin, gingerol, shoagol, cinnamon oleoresin, cassia oleoresin, cinnamic aldehyde, eugenol, cyclic acetal of vanillin, menthol glycerin ether, unsaturated amides and combinations thereof.

11. A chewing gum product comprising:
a) a gum base;
b) a bulking and sweetening agent;
c) a flavor;
d) a hydrophobic sweetener;
e) an additional sensory component; and
f) a trigeminal stimulant present in an amount below the perceived threshold but sufficient to stimulate the trigeminal nerve of a consumer.

12. The chewing gum product of claim 11 wherein the trigeminal stimulant is selected from the group consisting of: menthol, WS3, N-substituted p-menthane carboxamide, acyclic carboxamides including WS23, methyl succinate and menthone glycerol ketals, other like cooling agents or mixtures thereof.

13. The chewing gum product of claim 11 wherein the trigeminal stimulant is selected from the group consisting of: a flavor, a tingling agent, Jambu extract, Vanillyl alkyl ethers, Vanillyl n-butyl ether, spilanthol, Echinacea extract, Northern Prickly Ash extract, capsaicin, capsicum oleoresin, red pepper oleoresin, black pepper oleoresin, piperine, ginger oleoresin, gingerol, shoagol, cinnamon oleoresin, cassia oleoresin, cinnamic aldehyde, eugenol, cyclic acetal of vanillin, menthol glycerin ether, unsaturated amides and combinations thereof.

14. A method of making a chewing gum product having improved flavor duration comprising the steps of:
a) forming a chewing gum composition comprising from about 5% to about 95% gum base, from about 5% to 95% bulking and sweetening agents and from about 0.1% to about 15% of a flavor; and
b) adding less than about 0.5% of a trigeminal stimulant.

15. The method of claim 14 wherein the trigeminal stimulant is a cooling agent selected from the group consisting of: menthol, WS3, N-substituted p-menthane carboxamide, acyclic carboxamides including WS23, methyl succinate and menthone glycerol ketals, other like cooling agents or mixtures thereof.

16. The method of claim 14 wherein the trigeminal stimulant is a bulk sweetener with a negative heat of reaction.

17. The method of claim 14 wherein the flavor is a mint flavor.

18. The method of claim 14 wherein the flavor is a fruit flavor.

19. The method of claim 14 wherein the chewing gum product is a sugarless chewing gum.

20. The method of claim 14 wherein the flavor is regular bubblegum.

21. The method of claim 14 further wherein the chewing gum composition further comprises a hydrophobic sweetener.

22. The method of claim 14 wherein the chewing gum further comprises additional sensory active components.

23. The method of claim 14 wherein the trigeminal stimulant is selected from the group consisting of a flavor, a tingling agent, Jambu extract, Vanillyl alkyl ethers, Vanillyl n-butyl ether, spilanthol, Echinacea extract, Northern Prickly Ash extract, capsaicin, capsicum oleoresin, red pepper oleoresin, black pepper oleoresin, piperine, ginger oleoresin, gingerol, shoagol, cinnamon oleoresin, cassia oleoresin, cinnamic aldehyde, eugenol, cyclic acetal of vanillin, menthol glycerin ether, unsaturated amides and combinations thereof.

24. A method of extending the apparent flavor of a chewing gum product comprising the steps of:
a) forming a chewing gum composition comprising from about 5% to about 95% gum base, from about 5% to 95% bulking and sweetening agents and from about 0.1% to about 15% of a flavor; and
b) adding less than about 0.5% of a cooling agent to the chewing gum composition, wherein the cooling agent stimulates a trigeminal nerve of a consumer of the chewing gum product to extend the flavor of the chewing gum.

25. The method of claim 24 wherein the cooling agent is selected from the group consisting of: menthol, WS3, N-substituted p-menthane carboxamide, acyclic carboxamides including WS23, methyl succinate and menthone glycerol ketals, other like cooling agents or mixtures thereof.

26. The method of claim 24 wherein the chewing gum includes less than the typical amount of a cooling agent that is used to achieve a cooling effect.

27. A chewing gum product having improved sensory benefits by stimulating a trigeminal nerve of a consumer of the chewing gum product comprising:
a) about 5% to about 95% by weight gum base;
b) about 5% to about 95% by weight bulking and sweetening agents;
c) about 0.1% to about 15% by weight of a flavor; and
d) about 0.005% to about 0.5% by weight of a trigeminal stimulant.

28. The chewing gum product of claim 27 wherein the trigeminal stimulant is selected from the group consisting of: menthol, WS3, N-substituted p-menthane carboxamide, acyclic carboxamides including WS23, methyl succinate and menthone glycerol ketals, other like cooling agents or mixtures thereof.

29. The chewing gum product of claim 28 wherein the chewing gum includes less than the typical amount of cooling agent that is used to achieve a cooling effect.

30. The method of claim 27 wherein the trigeminal stimulant is a bulk sweetener with a negative heat of reaction.

31. The method of claim 27 wherein the trigeminal stimulant is selected from the group consisting of a flavor, a tingling agent, Jambu extract, Vanillyl alkyl ethers, Vanillyl n-butyl ether, spilanthol, Echinacea extract, Northern Prickly Ash extract, capsaicin, capsicum oleoresin, red pepper oleoresin, black pepper oleoresin, piperine, ginger oleoresin, gingerol, shoagol, cinnamon oleoresin, cassia oleoresin, cinnamic aldehyde, eugenol, cyclic acetal of vanillin, menthol glycerin ether, unsaturated amides and combinations thereof.

32. The method of claim 27 wherein a delayed release of trigeminal stimulation is achieved.
